(19) United States
(12) Patent Application Publication
(10) Pub. No.: US 2026/0269522 A1
(43) Pub. Date: Sep. 10, 2026

(54) Electrical Plug and Electrical Plug Receptacle

(71) Applicant: TE Connectivity Solutions GmbH, Schaffhausen (CH)

(72) Inventors: Martin SZELAG, BENSHEIM (DE); Kartik THAKUR, s-Hertogenbosch (NL)

(73) Assignee: TE Connectivity Solutions GmbH, Schaffhausen (CH)

(21) Appl. No.: 19/558,549

(22) Filed: Mar. 6, 2026

(30) Foreign Application Priority Data
Mar. 10, 2025 (DE) 102025109048.3

(51) Int. Cl. H01R 13/629; H01R 13/627

(52) U.S. Cl. CPC H01R 13/62933; H01R 13/6272

(57) ABSTRACT

An electrical plug comprising: a plug contact region, arranged on a plug body, with at least one electrical contact for establishing an electrical connection between the plug and at least one corresponding electrical mating contact of the plug socket; and a lever structure extending at least partially in the plugging direction and being deflectable substantially perpendicularly to the plugging direction at least between a first latching position and a second latching position. Arranged on the lever structure is a first plug latching element, configured to lock the plug to the socket latching element when the lever structure is in the first latching position; and a second plug latching element, configured to lock the plug to the frame latching element when the lever structure is in the second latching position. The first plug latching element does not to lock the plug to the socket latching element in the second latching position.

### CROSS-REFERENCE TO RELATED APPLICATION

This application claims the benefit of German Patent Application No. 102025109048.3 filed on Mar. 10, 2025 in the German Patent Office, which is hereby incorporated by reference in its entirety.

### BACKGROUND OF THE INVENTION

The invention relates to an electrical plug and to a corresponding electrical plug socket.

A large number of electrical connections are known in electrical engineering which serve to transmit electrical signals or voltages and, where appropriate, electrical currents with a largest possible bandwidth of voltages, data rates or frequencies, and electrical currents.

A subgroup of such connections is characterized by fastening and/or locking mechanisms which are arranged on the plug and interact with corresponding mating pieces arranged on the plug socket, in order to prevent undesired detachment of the plug connection between the plug and the plug socket and/or to improve the quality of the signal transmission. Plugs of the abovementioned type are to be found, inter alia, but not exclusively, in the field of communications or network technology, where, for example, the RJ (registered jack) plug connector system is applied in various designs and makes available a detachable plug connection which is mechanically robust to a certain extent.

The detachable locking between the plug and the plug socket is typically achieved in the case of the RJ plug connector system by a pair of corresponding latching means which are arranged on the plug and plug socket and substantially automatically engage in each other when the connection is established and can be detached, for example, by actuating an elastically deflectable lever arranged on the plug.

In order to increase the resilience of the connection, it has been proposed to equip the connection with two such pairs of latching means which are simultaneously engaged when the connection between the plug and the plug socket is established.

It has, however, become apparent that this presents challenges for the production of both the plug and the plug socket in terms of the tolerances and play compensation to be observed because just small deviations in the geometry of the connection can mean that in each case one of the two latched connections does not engage properly or does not allow the load transfer. Further challenges relate to the mechanisms for detaching the latched connection because, when the plug is detached quickly or carelessly from the latched connection, one of the two pairs of latching means is often completely detached before the in each case other pair, and, when the plug is subsequently or simultaneously pulled out, the components of the pair of latching means which has not yet been completely detached slide over each other in an unplanned fashion, which results in increased wear or even in damage to one or more of the components of the plug connection.

### SUMMARY OF THE INVENTION

One object of the invention is to at least partially overcome the abovementioned disadvantages and to specify an improved electrical plug and an improved electrical plug socket module. A further object of the invention is to specify an alternative electrical plug and an alternative electrical plug socket module.

The object of the invention is achieved by way of an electrical plug according to claim 1 and by way of an electrical plug socket module according to claim 18. Advantageous developments, additional features and/or advantages of the invention can be found in the dependent claims and the following description.

According to a first aspect, disclosed in this document is: an electrical plug, which can be connected in a plugging direction to an electrical plug socket module, the plug socket module comprising, in a first configuration, a plug socket with a socket latching element and, in a second configuration, the plug socket as well as a frame, connected to the plug socket, with a frame latching element, the electrical plug comprising: a plug contact region, arranged on a plug body, with at least one electrical contact for establishing an electrical connection between the plug and at least one corresponding electrical mating contact of the plug socket; a lever structure extending at least partially in the plugging direction and being deflectable substantially perpendicularly to the plugging direction at least between a first latching position and a second latching position. Arranged on the lever structure, a first plug latching element, configured to lock the plug to the socket latching element when the lever structure is in the first latching position; and a second plug latching element, configured to lock the plug to the frame latching element when the lever structure is in the second latching position. The first plug latching element is configured not to lock the plug to the socket latching element in the second latching position.

It has to date not been known for the abovedefined electrical plug to be configured to be locked to the plug socket module 100 both in the first configuration and in the second configuration, wherein in each case only one locking connection is active. As a result, the plays required in each case between the latching means at the plug and at the plug socket are advantageously largely decoupled from each other. Moreover, the problems occurring in the prior art in the context of multiple latching connections when detaching the plug connection are avoided because no forced detachment of one of the two latching connections takes place when the in each case other latching connection is detached prematurely.

The lever structure can be configured such that, when a connection is established with the plug socket module in the first configuration, it is deflected into the first latching position and, when a connection is established with the plug socket module in the second configuration, it is deflected into the second latching position. This is achieved in embodiments by the arrangement of inclined faces on the plug latching elements and/or on the socket latching element and/or on the frame latching element.

The plug body can be delimited in the plugging direction by a first end, wherein the lever structure comprises at least one elastic hinge section which is connected to the plug body in a region of the first end of the plug body.

The hinge section can be shaped in such a way that the lever structure protrudes in an undeflected position from the plug body at least partially at an acute angle.

The first plug latching element can have a first distance from the plug body in the first latching position of the lever structure and a second distance from the plug body in the second latching position.

The first distance can be configured in such a way that the first plug latching element, in a plugged configuration between the plug and the plug socket module, bridges a corresponding distance between the plug body and the socket latching element.

The second distance can be configured in such a way that the first plug latching element, in a plugged configuration between the plug and the plug socket module, does not bridge a corresponding distance between the plug body and the socket latching element.

The first plug latching element can comprise at least one first latching lug that protrudes laterally from the lever structure, perpendicular to the plugging direction and substantially parallel to a first surface of the plug body, and preferably a second latching lug formed mirror-symmetrically with respect to a first latching lug with reference to a central axis of the lever structure.

The second plug latching element can comprise a third latching lug that protrudes from the lever structure perpendicular to the plugging direction and substantially perpendicular to a first surface of the plug body.

The electrical plug can comprise at least one abutment element oriented, at least in part, substantially perpendicular to the plug body and configured to prevent displacement of the lever structure relative to the plug body in the plugging direction when the lever structure is in the second latching position.

The at least one abutment element can be configured to contact at least one corresponding mating abutment structure arranged on the lever structure when the lever structure is in the second latching position.

The at least one mating abutment structure can comprise a recess, arranged in the lever structure, which receives the at least one abutment element at least partially when the lever structure is in the second latching position.

The at least one mating abutment structure can be formed at least partially by a first surface, oriented perpendicular to the plugging direction, of the first plug latching element.

By virtue of the abovedefined embodiment, the first plug latching element also assumes in the second configuration of the plug socket module a function which is, however, separate from the function in connection with the locking in the first configuration of the plug socket module.

The at least one abutment element can be arranged between the first end of the plug body and the first plug latching element with reference to the plugging direction, and the first plug latching element can be arranged between the first end and the second plug latching element.

By virtue of the abovedefined arrangement, the lever structure is divided into a first lever section between the hinge section and the first plug latching element, and a second lever section between the first plug latching element and the second plug latching element. The transmission of an extraction force acting unintentionally on the plug to the plug socket module is achieved in the first configuration of the plug socket module by a compressive force, acting in the first lever section, which short-circuits the hinge section with the at least one socket latching element in terms of force.

In the second configuration of the plug socket module in which the latter comprises the frame, an extraction force acting unintentionally on the plug is imparted via the at least one abutment element to the second lever section and is transmitted to the frame as a compressive force via the second plug latching element.

In both configurations of the plug socket module, therefore in each case only one section of the lever structure is used for the force transmission, which reduces the risk of the lever structure buckling.

The electrical plug can comprise an actuating section, arranged on the lever structure, which is configured such that a user can deflect the lever structure by deflection of the actuating section into a detached position, wherein the first plug latching element is configured not to lock the plug to the socket latching element in the detached position, and the second plug latching element is configured not to lock the plug to the frame latching element in the detached position.

The first plug latching element can be configured such that in the first configuration, when a plugged configuration between the plug and the plug socket module is established, the lever structure is deflected by the socket latching element into the first latching position; and the second plug latching element can be configured such that in the second configuration, when a plugged configuration between the plug and the plug socket module is established, the lever structure is deflected by the frame latching element into the second latching position.

The lever structure can here have in the second latching position a distance from the plug body which is smaller than in the first latching position, and in the detached position a distance from the plug body which is smaller than in the second latching position.

The lever structure can comprise a first lever extending from the elastic hinge section in a direction opposite to the plugging direction, wherein the first plug latching element and the second plug latching element are arranged on the first lever.

In this embodiment, the lever structure is thus designed as a single piece and comprises a single lever extending from the hinge section in a cantilevered fashion along the plug body.

In embodiments, the lever structure comprises a first lever extending from the elastic hinge section in a direction opposite to the plugging direction, and a second lever extending from the plug body in the plugging direction, wherein, in a direction perpendicular to the plugging direction, a first free lever end of the first lever is arranged between the plug body and a second free lever end of the second lever.

In this embodiment, the lever structure is thus divided into two parts and comprises two levers extending in opposite directions in a cantilevered fashion from the plug body. The second lever can here be connected to the plug body via a second elastic hinge section.

The first plug latching element can be arranged on the first lever and the second plug latching element on the second lever.

By virtue of the abovedefined arrangement in which the first free lever end of the first lever is arranged, with respect to the direction perpendicular to the plugging direction, between the plug body and a second free lever end of the second lever, by pressing the second lever in the direction of the plug body the first lever is also deflected in the direction of the plug body. By virtue of this deflection, the position of the first plug latching element and of the second plug latching element perpendicular to the plugging direction is changed.

The lever structure is configured to be deflected by actuating the second lever into the detached position. In the detached position, the first plug latching element is configured not to lock the plug to the socket latching element. Moreover, in the detached position, the second plug latching element is configured not to lock the plug to the frame latching element.

According to a further aspect, disclosed in this document is: a plug socket module comprising: in a first configuration, a plug socket for connection to an electrical plug in a plugging direction, the plug socket comprising: at least one mating contact for establishing an electrical connection between the plug socket and at least one corresponding electrical contact of the plug; at least one socket latching element, configured to lock the plug socket to a corresponding first plug latching element of the plug; in a second configuration, the plug socket and a frame rigidly connected to the plug socket, the frame comprising: a frame latching element for locking the frame to a second plug latching element of the plug when the plug is inserted into the plug socket. The socket latching element is configured not to lock the plug socket to the first plug latching element in the second configuration.

The advantages of the electrical plug socket module result in a similar fashion to the abovedescribed advantages of the electrical plug.

### BRIEF DESCRIPTION OF THE DRAWINGS

The invention is explained in detail below on the basis of exemplary embodiments with reference to the attached drawings. In the drawings:

FIG. 1 shows a perspective view of a plugged configuration of an embodiment of a plug and of a plug socket module in a first configuration;

FIG. 2 shows a perspective view in partial section of a plugged configuration of an embodiment of a plug and of a plug socket module in a first configuration;

FIG. 3 shows a view in section of a plugged configuration of an embodiment of a plug and of a plug socket module in a first configuration;

FIG. 4a shows perspective view of a first embodiment of a plug;

FIG. 4b shows perspective view of a second embodiment of a plug;

FIG. 5 shows a perspective view in partial section of a plugged configuration of an embodiment of a plug and of a plug socket module in a second configuration;

FIG. 6 shows a perspective view in partial section of a plugged configuration of an embodiment of a plug and of a plug socket module in a second configuration;

FIG. 7a shows a perspective view of a plug socket;

FIG. 7b shows a perspective view of a frame; and

FIG. 8 shows a view in section of a plugged configuration of an embodiment of a plug and of a plug socket module in a first configuration.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

Moreover, the features and benefits of the invention are illustrated by reference to the preferred embodiments. Accordingly, the invention expressly should not be limited to such embodiments illustrating some possible non-limiting combination of features that may exist alone or in other combinations of features, the scope of the invention being defined by the claims appended hereto.

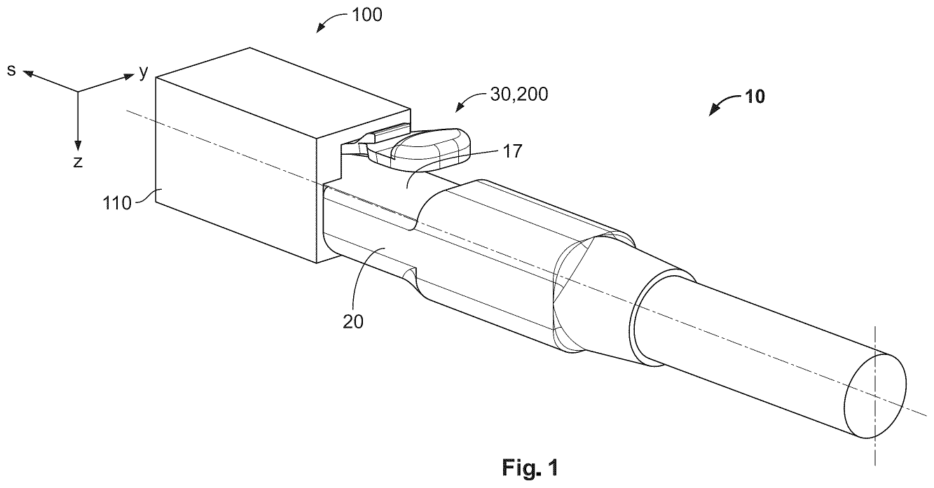

The structure and the functioning of an electrical plug 10 is described schematically below on the basis of FIGS. 1 to 8, as is an electrical plug socket module 100. Corresponding reference signs are used here for corresponding features.

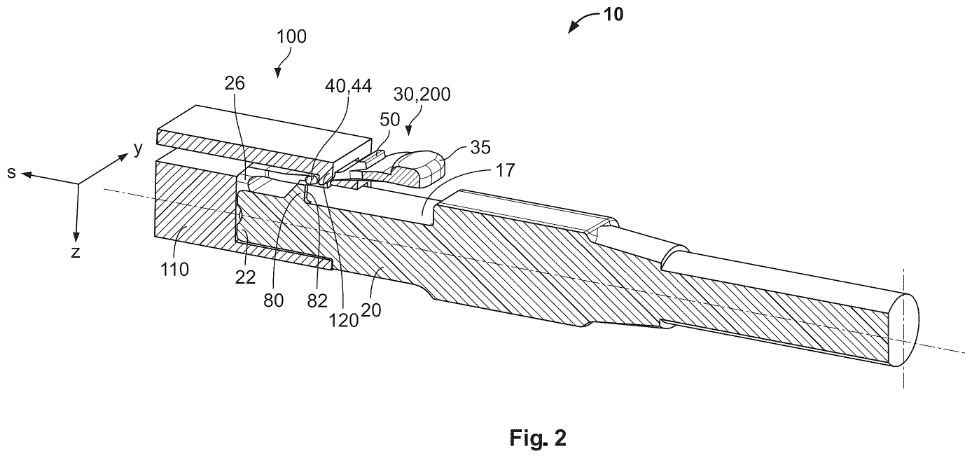

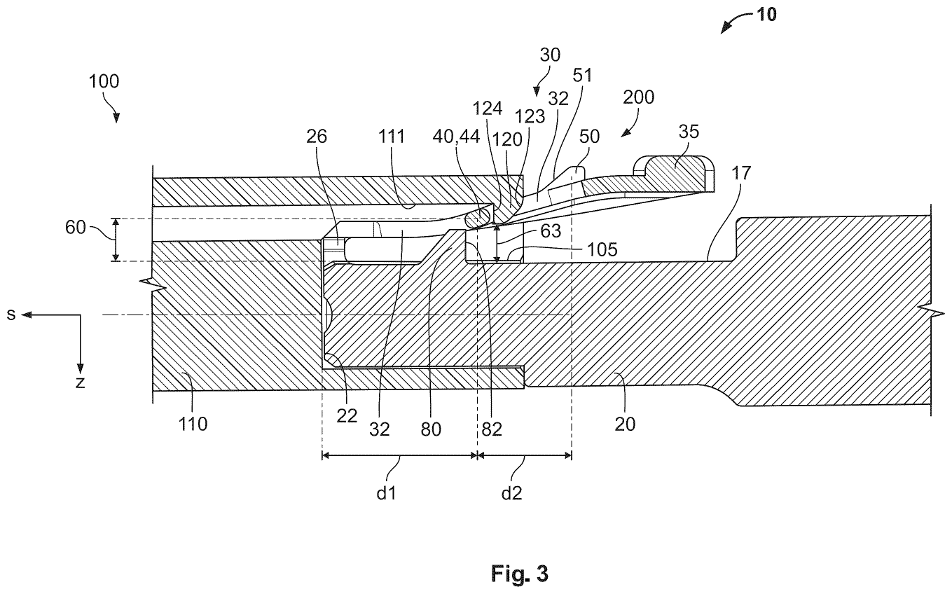

FIGS. 1 to 3 show views of the electrical plug 10 and of the electrical plug socket module 100 in a configuration connected in a plugging direction S. FIGS. 2 and 3 show views in section of the embodiment illustrated in FIG. 1.

The plug 10 is, in a manner known per se, connected electrically and mechanically to a, for example, two-core electrical conductor 5 for transmitting electrical signals. The plug socket 110 in turn is (in a manner not illustrated) also connected to electrical conductors which can, for example, be printed on a printed circuit board.

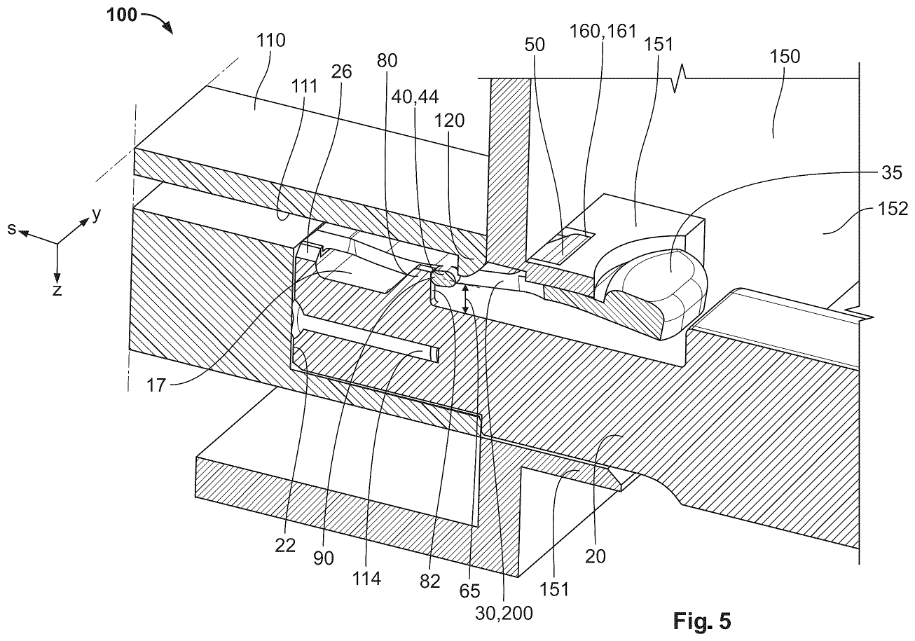

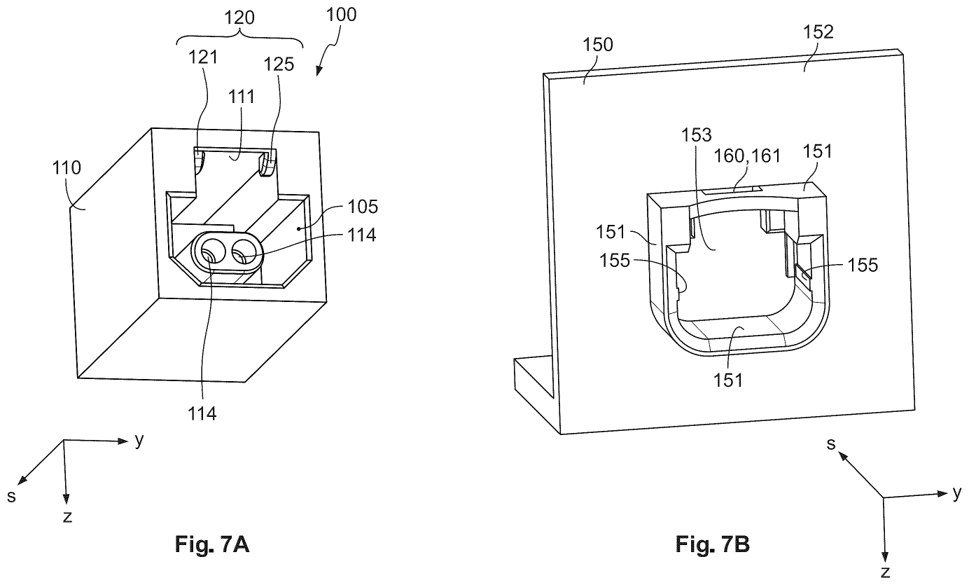

The plug socket module 100 is illustrated in FIGS. 1 to 3 in a first configuration which is also shown in FIG. 7. In the first configuration, the plug socket module 100 comprises a plug socket 110 with two socket latching elements 120. In a second configuration of the plug socket 110, which will be described in more detail in connection with FIGS. 5, 6 and 7b, the plug socket module 100 moreover also comprises a frame 150 which can be connected rigidly to the plug socket 110, makes available further bearing faces for the plug 10, and thus makes the connection stiffer.

The plug 10 comprises a plug body 20 on which, at a first end 22 thereof, a plug contact region 13 is arranged with two electrical contacts 15 for establishing an electrical connection between the plug 10 and corresponding mating contacts 114 of the plug socket 110. The plug body 20 itself is produced at least in part from an electrically insulating material such that the electrical contacts 15 are insulated with respect to an outer surface of the plug body 20.

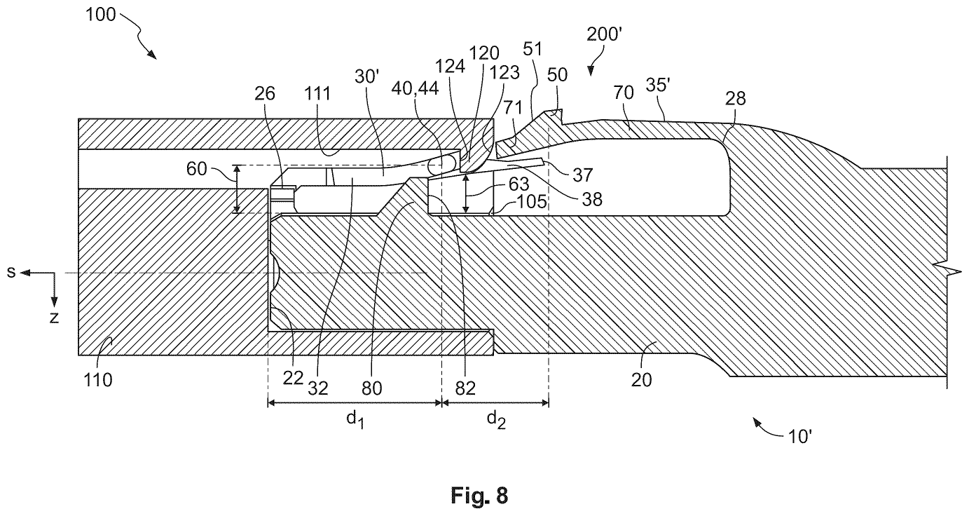

Likewise, in a region of the first end 22, a lever structure 200 is connected to the plug body 20 via an elastic hinge section 26 of the lever structure 200. In the embodiments described below in connection with FIGS. 1 to 6, the lever structure 200 is designed as a single piece and comprises a single lever which is referred to below as the first lever 30. The elastic hinge section 26 is thus arranged on the first lever 30 and the terms lever structure and first lever can be used synonymously in connection with these embodiments. In connection with FIG. 8, an embodiment will subsequently be described in which the lever structure 200 comprises a first lever 30′ and a second lever 70.

In the side view in FIG. 3, the first lever 30 curves in a slight S-shape and extends substantially in the plugging direction S. In the embodiments illustrated in the Figures, the hinge section 26 is shaped in such a way that the first lever 30 protrudes in an undeflected position from the plug body 20 at least partially at an acute angle.

The elastic hinge section 26 allows deflection of the first lever 30 in a direction perpendicular to the plugging direction S which is indicated in the figures as the z direction. The first lever 30 can thus be deflected at least into a detached position, a first latching position, and a second latching position, which will be described subsequently in more detail.

The first lever 30 is illustrated in FIGS. 1 to 3 in the first latching position. In the first latching position, a first plug latching element 40, which is arranged on the lever 30 at a first distance d1 from the first end 22 of the plug body 20, as can be seen in FIGS. 2 and 3 in the plugged configuration between the plug 10 and the plug socket module 100, interacts with the socket latching element 120 in such a way that detachment of the plug 10 from the plug socket module 100 is prevented. In this connection, the wording will also be used below that the first plug latching element 40 locks the plug 10 to the socket latching element 120 in the first latching position of the lever 30.

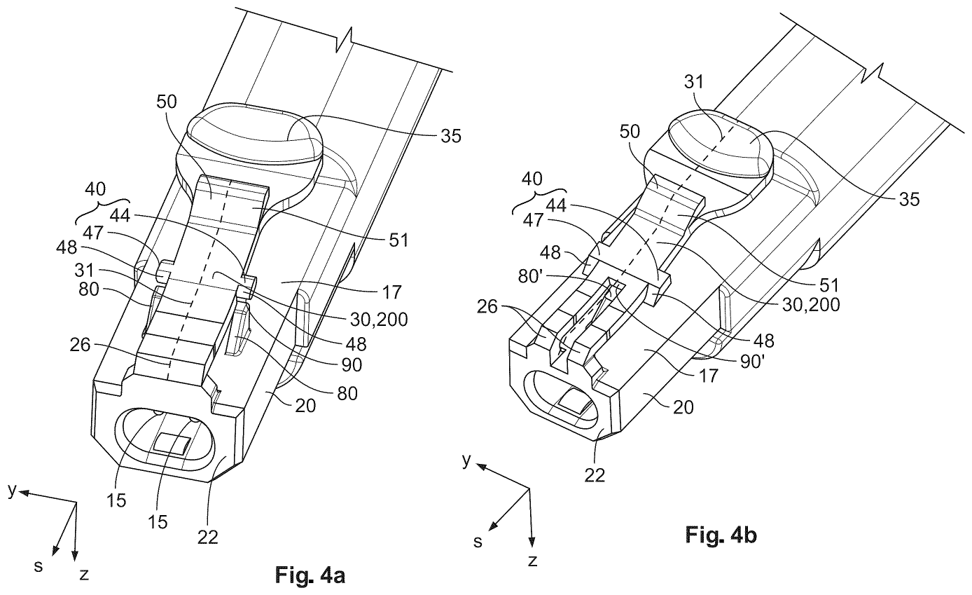

In the embodiments illustrated in the figures, the first plug latching element 40 comprises a first latching lug 44 that protrudes from the first lever 30 substantially perpendicularly, and a second latching lug 47 situated opposite the first latching lug 44 with reference to the lever 30. The first latching lug 44 and the second latching lug 47 are oriented perpendicular to the plugging direction S, are thus oriented in the y direction with reference to the Cartesian coordinate system shown in the figures, and are formed mirror-symmetrically with reference to a central axis 31 of the first lever 30, which central axis is shown in FIG. 4. The first latching lug 44 and the second latching lug 47 run substantially parallel to a first surface 17, oriented towards the first lever 30, of the plug body 20.

The socket latching element 120 comprises, in the embodiments illustrated in the figures, a first latching projection 121 and a second latching projection 125, which can be understood, for example, on the basis of FIG. 7a. The two latching projections 121 and 125 here protrude, inside a main opening 105 formed by the plug socket 110 for receiving the plug 10 in the plugging direction S, from an inner wall 111 of the plug socket 110 perpendicular to the plugging direction S. A main direction of extent of the two latching projections 121 and 125 is here oriented in the z direction.

The first lever 30 is configured such that, when a connection of the plug 10 to the plug socket module 100 present in the first configuration is established, it is deflected into the first latching position, which will be explained in detail below on the basis of FIGS. 3 and 4a.

FIG. 4a shows the plug 10 in an unplugged configuration, i.e. in a configuration in which it is not connected to the plug socket module 100. The first lever 30 is here in a free position in which it protrudes freely from the plug body 20 at an acute angle to the plugging direction S.

FIGS. 2 and 3 show the plug 10 and the plug socket module 100 in the plugged configuration. A person skilled in the art will recognize, for example, on the basis of viewing FIGS. 2 to 4a together, that the plug 10 is plugged into the main opening 105 of the plug socket 110 in the plugging direction S in order to establish the plugged configuration. It should be mentioned at this point that, in terms of the definition of directions within the scope of the application, it is the case that the plug 10 is moved “in” the plugging direction S in order to establish the connected or plugged configuration between the plug 10 and the plug socket module 100, and “in a direction opposite to” the plugging direction S in order to establish a detached configuration in which the plug 10 and the plug socket module 100 are not connected.

In the course of this process, the first latching lug 44 and the second latching lug 47 of the plug latching element 40 contact the latching projections 121 and 125 of the socket latching element 120 in each case in a region of a flank section 123 inclined with respect to the plugging direction S. The flank sections 123 are oriented such that they elastically deflect the first lever 30 as they continue to move in the plugging direction S in the direction of the first surface 17 of the plug body 20, i.e. in the direction of the positive z axis, such that ultimately the first latching lug 44 and the second latching lug 47 of the plug latching element 40 are situated, with reference to the z axis, between the first latching lug 44 or the second latching lug 47 and the first surface 17 and can thus be moved past the latching lugs 44, 47 in the plugging direction S. The distance perpendicular to the plugging direction S, which is set when the plugged connection between the plug body 20 and the socket latching element 120 is established, and below which the first latching lug 44 and second latching lug 47 are pressed into the plug socket when the plug 10 is plugged in, is also referred to in the present disclosure as the corresponding distance 63.

After it has passed the latching lugs 44, 47, the first lever 30 is pressed by elastic restoring forces in a direction opposite to the direction of the positive z axis into the first latching position shown in FIG. 3 in which the first plug latching element 40 has a first distance 60 from the plug body 20 and locks the plug 10 to the socket latching element 120. As can be seen in FIG. 3, when it has the first distance 60 between the first plug latching element 40 and the plug body 20, the first plug latching element 60, in the plugged configuration between the plug 10 and the plug socket module 100, bridges the corresponding distance 63 between the socket latching element 120 and the plug body 20. A flank 124, oriented perpendicular to the plugging direction S, of the socket latching element 120 is oriented towards the inside of the plug socket 110 and thus prevents undesired displacement of the plug 10 in a direction opposite to the plugging direction S.

If a force directed in a direction opposite to the plugging direction S is applied to the plug 10 in the plugged configuration with the plug socket 10 in the first configuration, i.e. without a frame 150, a compressive force is applied to a first lever section 32 of the first lever 30 which runs between the hinge section 26 and the first plug latching element 40, i.e. in FIG. 3 the section of the first lever 30 which is situated in a region of the first distance d1.

In order to detach the plug 10 from the plug socket 110, the first lever 30 is configured such that, in a region of an actuating section 35 arranged on an end of the first lever 30 remote from the hinge section 26, it is deflectable in the direction of the first surface 17 of the plug body 20, i.e. in the direction of the positive z axis, into a detached position in which the first latching lug 44 and the second latching lug 47 of the plug latching element 40 are situated between the first latching lug 44 or the second latching lug 47 and the first surface 17. The distance between the first plug latching element 40 and the plug body 20 in this configuration does not bridge the corresponding distance 63 between the socket latching element 120 and the plug body 20, and the first plug latching element 40 thus is not locked to the socket latching element 120 in the detached position. The plug 10 can therefore be pulled from the plug socket 110 in a direction opposite to the plugging direction S.

With reference to the first latching lug 44 and the second latching lug 47 of the first plug latching element 40, it should be noted that in embodiments they have a shape which assists the abovedescribed deflection of the first lever 30 in the direction of the plug body 20 whilst the plugged configuration is being established. In the embodiments illustrated in FIGS. 4a and 4b, for example, the first latching lug 44 and the second latching lug 47 in each case have a sloping section 48, oriented at a flat angle to the plugging direction S, which is oriented such that, when it contacts the socket latching element 120 as the plug 10 is plugged into the plug socket 110, it assists deflection of the first lever 30 in the direction of the plug body 20. In these embodiments, the sloping section 48 of the first plug latching element 40 and the flank section 123 of the socket latching element 120 thus slide on each other when the plugged connection is established and thus facilitate deflection of the first lever 30 in the direction of the plug body 20.

FIG. 5 shows a perspective view in partial section of a plugged configuration between the plug 10 and the plug socket module 100 present in the second configuration.

As already explained, the plug socket module 100 has in the second configuration, in addition to the plug socket 110, a frame 150 rigidly connected to the plug socket 110. In the embodiments of FIGS. 5 to 7, the frame comprises a front panel 152, oriented perpendicular to the plugging direction S, in which a frame opening 153 is arranged. The plug socket 110 is arranged behind the front panel 152 in a region of the frame opening 153 and with reference to the plugging direction S. The plug socket 110 can, in a suitable manner not illustrated further, be retained on the frame, for example by a latching connection or by adhesive bonding. In embodiments, the plug socket 100 is designed as a single piece with the frame 150.

As can be seen in FIG. 5, the plug socket 110 is arranged in a region of the frame opening 153 in such a way that the frame opening 153 and the main opening 105 are situated substantially parallel and directly adjacent to each other such that they form a through opening into which the plug 10 is plugged in the plugging direction S. The first latching projection 121 and the second latching projection 125 of the plug latching element 120 thus project from the inner wall 111 of the main opening 105 into this through opening.

In a region of the frame opening 153 and in front of the front panel 152 with reference to the plugging direction S, in the embodiment illustrated in FIGS. 5 to 7 a peripheral flange 151 is arranged which protrudes perpendicularly from the front panel 152 in a direction opposite to the plugging direction S and thus makes available further bearing faces for the plug 10.

The frame 150, which can in turn be arranged, for example, in a plug panel of a switch cabinet, in a wall or on a desk thus fulfils both the object of holding the plug socket 110 and the object of stiffening the plugged connection between the plug 10 and the plug socket module or making it more robust. In order to improve the fit of the plug 10 in the plug socket module, in embodiments the inner sides of the peripheral flange 151 facing the plug 10 feature guide ribs 155 which are oriented in the plugging direction S and eliminate manufacturing-related play.

The frame 150 is configured to provide a locking connection with the plug 10 which acts independently of the abovedescribed locking connection between the plug socket 110 and the plug 10.

For this purpose, arranged on the frame 150 is a frame latching element 160 which, as illustrated in FIGS. 5 to 7, can be designed as an opening 161, oriented perpendicular to the plugging direction S, in the flange 151.

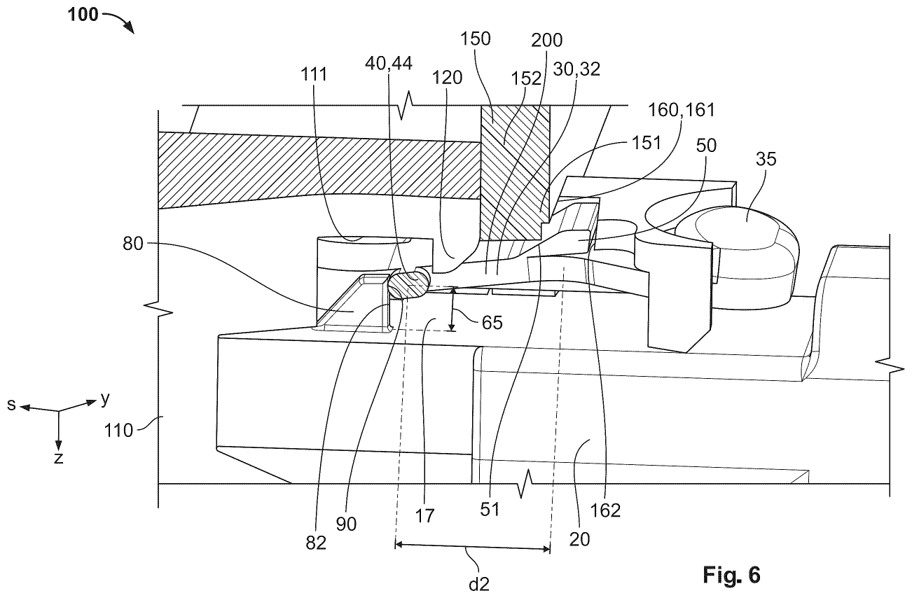

Arranged on the first lever 30 of the plug 10 is a second plug latching element 50 which corresponds with the frame latching element 160 and, in the embodiments of FIGS. 5 and 6, comprises a third latching lug 55 that protrudes from the first lever 30 perpendicular to the plugging direction S and substantially perpendicular to the first surface 17 of the plug body 20. The second plug latching element 50 is configured to lock the plug 10 to the frame latching element 160 when the first lever 30 is in the second latching position.

This state is illustrated in FIGS. 5 and 6. The second plug latching element 50 here projects through the opening 161 of the frame latching element 160 and contacts an end face 162, oriented in the plugging direction S, of the opening 161. Forces can in this way be transmitted between the frame latching element 160 and the end face 162 parallel to the plugging direction S when an extracting force is exerted to the plug 10 in a direction opposite to the plugging direction S, whilst the first lever 30 is in the second latching position.

The section of the flange 151 in which the frame latching element 160 is arranged is here arranged on the frame 150 and in the plugged configuration with a fourth distance 68 from the plug body 10 in such a way that the first lever 30 is elastically deflected towards the plug body 20 in the direction of the positive z direction. The restoring forces in the first lever 30 which are mobilized by this deflection pretension the second plug latching element 50 into the opening 161 of the frame latching element 160.

When the plugged configuration between the plug 10 and the plug socket module 100 is established, the plug 10 is pushed into the frame opening 153 in the plugging direction S. The first lever 30 thus contacts, in a region of the second plug latching element 50, the peripheral flange 151 in a region in which the frame latching element 160 is arranged. The second plug latching element 50 has an inclined face 51 oriented in the plugging direction S and which is thus inclined with respect to the plugging direction S such that it assists sliding of the second plug latching element 50 on the peripheral flange 151 in the direction of the plug body 20. As soon as the second plug latching element 50, as the movement continues in the plugging direction S, moves into the region of the opening 161 of the frame latching element 160, the latching between the two latching elements 50, 160 takes place by virtue of the restoring forces present in the first lever 30.

As can be seen in FIGS. 5 and 6, in the second latching position the first plug latching element 40 has a second distance 65 from the first surface 17 of the plug body 20 which is smaller than the corresponding distance 63 between the socket latching element 120 and the plug body 20. In the plugged configuration between the plug 10 and the plug socket module 100, the first plug latching element 40 thus does not bridge the corresponding distance 63 between the plug body 20 and the socket latching element 120. Accordingly, in the second latching position the first plug latching element 40 is not locked to the first socket latching element 120 and the plug 10 is only locked against being pulled out in a direction opposite to the plugging direction S by the interaction of the second plug latching element 50 with the frame latching element 160 at the plug socket module 100.

Whilst, in the embodiments illustrated in FIGS. 5 to 7, the first plug latching element 40 thus does not prevent the plug 10 from being inadvertently pulled out, it does fulfil another function in connection with the locking of the second plug latching element 50 to the frame latching element 160, as described below.

As can be seen, for example, in FIGS. 4 to 6, at least one abutment element 80, 80′ oriented substantially perpendicular to the plug body 20, i.e. in the z direction, is arranged on the plug body 20. The at least one abutment element 80, 80′ is arranged between the first end 22 of the plug body 20 and the first plug latching element 40 with reference to the plugging direction S. When the first lever 30 is in the second latching position, the abutment element 80, 80′ interacts with a mating abutment structure 90, 90′ arranged on the first lever 30 in order to prevent displacement of the first lever 30 relative to the plug body 20 in the plugging direction S. As a result, the first lever 30 is stiffened, which allows a smaller amount of play in the plugging direction S and higher transferable forces in the plugging direction S.

In the embodiments shown in FIGS. 2, 3, 4a, 5 and 6, two abutment elements 80 situated opposite each other with reference to the first lever 30 are arranged on the first surface 17 of the plug body 20 and in each case define a perpendicular abutment face 82 oriented in a direction opposite to the plugging direction S. The respective abutment face 82 extends from the first surface 17 as far as a height above the first surface 17 which corresponds at least to the second distance 65. The positions of the abutment elements 80 on the surface 17 in the y direction, i.e. perpendicular to the plugging direction S, are here selected such that the first latching lug 44 and the second latching lug 47 of the first plug latching element 40 have contact with the respective abutment surface 82 in a region of a respective first surface 42 when the first lever 30 is in the second latching position. The mating abutment structure 90 is thus provided by the first surfaces 42 which are oriented perpendicular to the plugging direction S.

In this way, the first lever 30 is supported by the interaction of the abutment elements 80 with the first plug latching element 40 in such a way that displacement of the first lever 30 in a direction opposite to the plugging direction S is prevented.

When a tensile force directed in a direction opposite to the plugging direction S is applied to the plug 10, it can thus be imparted to the first lever 30 via the abutment elements 80 and the first plug latching element 40, and conducted to the second plug latching element 50 via a second lever section 33, which can be seen for example in FIG. 6, of the first lever 30, which extends over a second distance d2. The extraction force is then imparted to the frame latching element 160 and the frame 150 at the second plug latching element 50.

In this way, a flow of the tensile force via the hinge section 26 of the first lever 30 is advantageously prevented, as a result of which deformations are avoided which would otherwise occur of the hinge section 26 which is inherently designed as relatively soft in order to allow the movements of the first lever 30 between the latching positions. The distance d2 over which the tensile force and the counterforce made available at the frame in the first lever 30 are short-circuited is moreover small compared with the situation where the tensile force is guided via the hinge section 26. The risk of the second section 32 buckling under load is thus reduced and the locking connection is stiffer. This means that higher tensile forces can be absorbed.

In the embodiment shown in FIG. 4b, a single abutment element 80′ is arranged centrally on the plug body 20, and the mating abutment structure 90′ comprises a recess 92 which is arranged in the first lever 30 and runs substantially along the central axis 31 of the first lever 30. Apart from the position on the plug body 20, the abutment element 80′ has substantially the same structure as one of the abutment elements 80 which have been described with reference to FIGS. 2 to 4a. As can be seen in FIG. 4b, the recess 92 partially receives the abutment element 80′ when the first lever 30 is in the second latching position. The length of the recess 92 parallel to the plugging direction S is dimensioned such that the first lever 30 cannot be displaced in a direction opposite to the plugging direction S when the first lever 30 is in the second latching position. The same advantages result from a mechanical point of view in terms of the force flow as described above with reference to the abutment elements 80, i.e. there is as direct as possible short-circuiting of the tensile force at the plug 10, with the frame latching element 160, via a short second lever section 32, under compression, of the first lever 30.

An advantage of the embodiment shown in FIG. 4b compared with the embodiment shown in FIG. 4a can be seen in the fact that the first plug latching element 40 does not serve, in terms of its functionality, as an abutment element 80 and thus its shape can be optimized for use as a latching element in the first latching position, for example in terms of the design of the sloping section 48. The position of the abutment element 80′ at a central location, the majority of which is covered by the first lever 30, of the plug body 20 is moreover advantageous. The latter is the case because there are no limitations of the height of the abutment element 80′ above the plug body 20 because of the socket latching elements 120. In contrast, the extent of the abutment elements 80 in this direction, which is the z direction in the figures, is limited in the embodiments shown in FIGS. 2 to 4a by the height which corresponds to the corresponding distance 63 because otherwise collision of the first plug latching elements 120 with the abutment elements 80 would hinder the insertion of the plug 10 into the plug socket 100.

In order to detach the plug 10 from the plug socket 110, as described in connection with the first configuration of the plug socket module 100, the actuating section 35 of the first lever 30 is deflected into the detached position in the direction of the first surface 17 of the plug body 20. The second plug latching element 50 has a height in the z direction, i.e. perpendicular to the plugging direction S, which is dimensioned such that the second plug latching element 50 is not locked to the frame latching element 160 in the detached position. The plug 10 can thus be pulled from the plug socket 110 in a direction opposite to the plugging direction S.

With reference to FIG. 8, an embodiment of a plug 10′ will be described below in which the lever structure 200′ comprises a first lever 30′ and a second lever 70. The reference signs for components of the plug 10′ which correspond to those components which have been described in connection with the embodiments of FIGS. 1 to 7 are preserved here.

The first lever 30′ on which the first plug latching element 40 is arranged extends from the elastic hinge section 26 in a direction opposite to the plugging direction S, which is also the case in connection with the embodiments described in FIGS. 1 to 6.

The second lever 70 is connected to the plug body 20 via a second elastic hinge section 28 and extends from the plug body 20 in the plugging direction S.

Whilst the embodiments described in connection with FIGS. 1 to 6 have a lever structure 200 with a single one-piece lever 30, in the embodiment illustrated in FIG. 8, the lever structure 200′ is divided into two parts and comprises two levers 30′, 70 extending in opposite directions in a cantilevered fashion from the plug body 20. A first free lever end 37 of the first lever 30′ is here arranged, with respect to the z direction shown in FIG. 8 which runs perpendicular to the plugging direction S, between the plug body 20 and a second free lever end 71 of the second lever 70. A distance between the first free lever end 37 and the second free lever end 71 is here configured such that it can be bridged by elastic deflection of the second free lever end 71 or can even be connected elastically between the element 71 and 37.

The second plug latching element 50 is, as can be seen in FIG. 8, arranged on the second lever 70. The arrangement of the first 40 and the second plug latching element 50 on the lever structure 200′ corresponds in terms of the structure of the plug latching elements 40, 50 to its orientation, as well as to the distances between the components in the plugging direction S, as well as perpendicular thereto, as has already been disclosed in connection with FIGS. 1 to 7.

As can be seen in FIG. 8, which shows the lever structure 200′ in the first latching position, the first plug latching element 40, which is arranged on the first lever 30′ at the first distance d1 from the first end 22 of the plug body 20, interacts, in the plugged configuration between the plug 10′ and the plug socket module 100, with the socket latching element 120 in such a way that detachment of the plug 10′ from the plug socket module 100 is prevented. The second plug latching element 50 is not involved with the locking of the plug 10′ in this configuration.

When the plugged configuration between the plug 10′ and the plug socket module 100 shown in FIG. 7b and present in the second configuration, i.e. with the frame 150, is established, the plug 10′ is pushed into the frame opening 153 in the plugging direction S. The second lever 70 thus contacts, in a region of the second plug latching element 50, the peripheral flange 151 in a region in which the frame latching element 160 is arranged. The sloping surface 51, oriented in the plugging direction S, of the second plug latching element 50 here assists sliding of the second plug latching element 50 on the peripheral flange 151 towards the plug body 20, and thus deflection of the second lever 70 in this direction. As soon as the second plug latching element 50, as the movement continues in the plugging direction S, moves into the region of the opening 161 of the frame latching element 160, the locking between the two latching elements 50, 160 takes place by virtue of the restoring forces mobilized in the second lever 70 by the deflection. The lever structure 200′ is then in the second latching position.

During the deflection of the second lever 70 into the second latching position, the second free lever end 71 of the second lever 70 contacts the first free lever end 37 of the first lever 30′ at a pressure point 38 and deflects the first free lever end 37 in the z direction towards the plug body 20.

By virtue of this deflection, the first plug latching element 40 is deflected such that it assumes a position which corresponds to the one which is shown in FIGS. 5 and 6. The second distance 65 of the first plug element 40 from the first surface 17 of the plug body 20 is here smaller than the corresponding distance 63 between the socket latching element 120 and the plug body 20. In the plugged configuration between the plug 10′ and the plug socket module 100, the first plug latching element 40 thus does not bridge the corresponding distance 63 between the plug body 20 and the socket latching element 120. Accordingly, in the second latching position the first plug latching element 40 is not locked to the first socket latching element 120 and the plug 10′ is only locked against being pulled out in a direction opposite to the plugging direction S by the interaction of the second plug latching element 50 with the frame latching element 160 at the plug socket module 100.

A person skilled in the art knows that, by pressing the second lever 70 in a region of a second actuating section 35′ in the direction of the plug body 20, the first lever 30′ can also be deflected in the direction of the plug body 20. By virtue of this deflection, the lever structure 200′ is deflected into the detached position. The second plug latching element 50 has a height in the z direction, i.e. perpendicular to the plugging direction S, which is dimensioned such that the second plug latching element 50 is not locked to the frame latching element 160 in the detached position. The second distance 65 of the first plug latching element 40 from the first surface 17 of the plug body 20 is moreover smaller in the detached position than the corresponding distance 63 between the socket latching element 120 and the plug body 20. The plug 10′ can thus be pulled from the plug socket 110 in a direction opposite to the plugging direction S.

The abovedescribed configurations have some advantages over the solutions known in the prior art in which two pairs of latching means are locked simultaneously. It is, for example, known to a person skilled in the art that, in the case of pairs of latching means in plug/plug socket configurations, the latching means must always be arranged in the plugging direction in such a way that certain tolerances are taken into account when the relevant components are manufactured. In other words, the latching means must be arranged in such a way that a certain play in the plugging direction is possible. When two pairs of latching means which are simultaneously engaged are arranged, these length tolerances of the two pairs of latching means influence each other and high demands have to be placed on the size accuracy. This requirement does not exist with the present solution in which in each case only one single pair of latching means is locked.

Moreover, the problems mentioned at the beginning are avoided when the connection is detached because only one pair of latching means is also engaged in the second configuration in which the plug socket module 100 comprises the frame 150.

The invention is not restricted to the exemplary embodiments described and illustrated. Rather, it also comprises all developments known to a person skilled in the art within the scope of the invention defined by the claims. In addition to the embodiments described and depicted, further embodiments are conceivable which may comprise further modifications and/or combinations of features.

1. An electrical plug, which can be connected in a plugging direction to an electrical plug socket module, the plug socket module comprising, in a first configuration, a plug socket with a socket latching element and, in a second configuration, the plug socket as well as a frame, connected to the plug socket, with a frame latching element, the electrical plug comprising:
a plug contact region, arranged on a plug body, with at least one electrical contact for establishing an electrical connection between the plug and at least one corresponding electrical mating contact of the plug socket;
a lever structure extending at least partially in the plugging direction and being deflectable substantially perpendicularly to the plugging direction at least between a first latching position and a second latching position;
and, arranged on the lever structure,
a first plug latching element, configured to lock the plug to the socket latching element when the lever structure is in the first latching position; and
a second plug latching element, configured to lock the plug to the frame latching element when the lever structure is in the second latching position;
wherein the first plug latching element is configured not to lock the plug to the socket latching element in the second latching position.

2. The electrical plug according to claim 1, wherein the plug body is delimited by a first end in the plugging direction, and wherein the lever structure comprises at least one elastic hinge section which is connected to the plug body in a region of the first end of the plug body.

3. The electrical plug according to claim 1, wherein the first plug latching element has a first distance from the plug body in the first latching position of the lever structure, and a second distance from the plug body in the second latching position.

4. The electrical plug according to claim 3, wherein the first distance is configured in such a way that the first plug latching element, in a plugged configuration between the plug and the plug socket module, bridges a corresponding distance between the plug body and the socket latching element.

5. The electrical plug according to claim 3, wherein the second distance is configured in such a way that the first plug latching element, in a plugged configuration between the plug and the plug socket module, does not bridge a corresponding distance between the plug body and the socket latching element.

6. The electrical plug according to claim 1, wherein the first plug latching element comprises at least one first latching lug that protrudes laterally from the lever structure, perpendicular to the plugging direction and substantially parallel to a first surface of the plug body, and preferably a second latching lug formed mirror-symmetrically with respect to the first latching lug with reference to a central axis of the lever structure.

7. The electrical plug according to claim 1, wherein the second plug latching element comprises a third latching lug that protrudes from the lever structure perpendicular to the plugging direction and substantially perpendicular to a first surface of the plug body.

8. The electrical plug according to claim 1, comprising at least one abutment element oriented, at least in part, substantially perpendicular to the plug body, and configured to prevent displacement of the lever structure relative to the plug body in the plugging direction when the lever structure is in the second latching position.

9. The electrical plug according to claim 8, wherein the at least one abutment element is configured to contact at least one mating abutment structure arranged on the lever structure when the lever structure is in the second latching position.

10. The electrical plug according to claim 9, wherein the at least one mating abutment structure comprises a recess, arranged in the lever structure, which receives the at least one abutment element at least partially when the lever structure is in the second latching position.

11. The electrical plug according to claim 10, wherein the at least one mating abutment structure is formed at least partially by a first surface, oriented perpendicularly with respect to the plugging direction, of the first plug latching element.

12. The electrical plug according to claim 8, wherein the at least one abutment element is arranged between the first end of the plug body and the first plug latching element with reference to the plugging direction, and the first plug latching element is arranged between the first end and the second plug latching element.

13. The electrical plug according to claim 1, comprising an actuating section, arranged on the lever structure, which is configured such that a user can deflect the lever structure by deflection of the actuating section into a detached position, wherein the first plug latching element is configured not to lock the plug to the socket latching element in the detached position, and the second plug latching element is configured not to lock the plug to the frame latching element in the detached position.

14. The electrical plug according to claim 1,
wherein, in the first configuration, the first plug latching element is configured such that, when a plugged configuration is established between the plug and the plug socket module, the lever structure is deflected by the socket latching element into the first latching position; and
wherein, in the second configuration, the second plug latching element is configured such that, when a plugged configuration is established between the plug and the plug socket module, the lever structure is deflected by the frame latching element into the second latching position.

15. The electrical plug according to claim 1, wherein the lever structure comprises a first lever extending from the elastic hinge section in a direction opposite to the plugging direction, and wherein the first plug latching element and the second plug latching element are arranged on the first lever.

16. The electrical plug according to claim 1, wherein the lever structure comprising a first lever extending from the elastic hinge section in a direction opposite to the plugging direction, and a second lever extending from the plug body in the plugging direction,
wherein, in a direction perpendicular to the plugging direction, a first free lever end of the first lever is arranged between the plug body and a second free lever end of the second lever.

17. The electrical plug according to claim 15, wherein the first plug latching element is arranged on the first lever and the second plug latching element is arranged on the second lever.

18. A plug socket module, comprising:
in a first configuration, a plug socket for connection to an electrical plug in a plugging direction, the plug socket comprising:
at least one mating contact for establishing an electrical connection between the plug socket and at least one corresponding electrical contact of the plug;
at least one socket latching element, configured to lock the plug socket to a corresponding first plug latching element of the plug;
in a second configuration, the plug socket and a frame rigidly connected to the plug socket, the frame comprising:
a frame latching element for locking the frame to a second plug latching element of the plug when the plug is inserted into the plug socket;
wherein the socket latching element is configured not to lock the plug socket to the first plug latching element in the second configuration.
